(19) United States
(12) Patent Application Publication
(10) Pub. No.: US 2025/0251926 A1
(43) Pub. Date: Aug. 7, 2025

(54) SOFTWARE UPDATE BASED VEHICLE ACTUATION

(71) Applicant: Ford Global Technologies, LLC, Dearborn, MI (US)

(72) Inventors: Huanyi Shui, Ann Arbor, MI (US); Devesh Upadhyay, Canton, MI (US); Thi Tu Trinh Tran, Royal Oak, MI (US); Anqi He, Amherst, MA (US); Santosh Pullala, Canton, MI (US)

(73) Assignee: Ford Global Technologies, LLC, Dearborn, MI (US)

(21) Appl. No.: 18/434,901

(22) Filed: Feb. 7, 2024

(51) Int. Cl. G06F 8/65

(52) U.S. Cl. CPC G06F 8/65

(57) ABSTRACT

A computer that includes a processor and a memory, the memory including instructions executable by the processor to receive data corresponding to a plurality of vehicles regarding a specified aspect of vehicle performance. An effectiveness of a software update targeted to the specified aspect of vehicle performance is determined based on the data, and when the determined effectiveness is below a specified threshold the system actuates a change in at least one of the plurality of a vehicles.

### BACKGROUND

Software updates can be used to address aspects of vehicle performance. Electric vehicles, for example, can benefit from software updates, e.g., over-the-air updates, to maintain battery performance. Due to complex interactions and varying operating conditions of different vehicles, a software update may affect vehicles differently. In addition, during a particular software update designed to address a particular aspect of vehicle performance, other software updates may also be pushed to the vehicle at or near the same time.

### BRIEF DESCRIPTION OF THE DRAWINGS

FIG. 1 is a block diagram of an example vehicle.

FIG. 2 is a process flow diagram illustrating an example process for software update based vehicle change actuation.

FIG. 3 is a block diagram of a causal machine learning based software effectiveness analysis.

FIG. 4 is a block diagram of a first level causal analysis.

FIG. 5 is a histogram illustrating a conditional average treatment effect.

FIG. 6 is a block diagram of a second level causal analysis.

FIG. 7 is a histogram illustrating an average treatment effect.

FIG. 8 is a graph illustrating the effect of software updates over time.

### DETAILED DESCRIPTION

This disclosure provides techniques for actuating a change in a vehicle state upon determining the effectiveness of a software update targeted to a specified aspect of vehicle performance using causal machine learning. Based on the effectiveness of the software update, the system can actuate a change in the vehicle that can include reverting the software to a previous version and/or disabling a component of the vehicle. Software updates may address aspects of vehicle performance. Electric vehicles, for example, can benefit from software updates, e.g., over-the-air updates, to maintain battery performance. A software update can be provided to address a particular issue in a fleet of vehicles, e.g., a battery drain caused by zone lighting remaining on after a vehicle is turned off. Due to complex interactions and varying operating conditions of different vehicles, a software update may affect various vehicles differently. In addition, during a particular software update provided to address a particular aspect of vehicle performance, other software updates may also be pushed to the vehicle at or near the same time.

In an example, a software update targeted to a specified aspect of vehicle performance is pushed out to a set of vehicles. Data, including vehicle features, warranty information, and vehicle telematics (e.g., diagnostic trouble codes), is gathered for vehicles with the software update (i.e., a treatment group) and vehicles without the software update (i.e., a control group). Conventional causal machine learning techniques (e.g., x-learner, s-learner, causal tree, etc.) are applied to the gathered data to build a causal model for performing conditional average treatment effect (CATE) calculations. The causal model is then used to perform a two-level causal analysis. The first level calculates CATE for the software update on outcomes related to vehicle performance. In other words, the first level indicates how the containment action, i.e., software update, changes the aspect of vehicle performance of interest. For example, the first level can determine if the software update increases or decreases the incidence of a particular diagnostic trouble code (DTC). The second level calculates average treatment effect (ATE) for feature groups on CATE calculated from the previous first level step. The second level indicates how different groups of features affect the change in CATE. This can be used to indicate which vehicle features are associated with changes in the vehicle performance caused by the software update. The causal effect of multiple software updates over time is evaluated by summing the effectiveness of the software update and one or more subsequent software updates over time.

Disclosed herein is a system including a computer having a processor and a memory. The memory includes instructions executable by the processor to receive data corresponding to a plurality of vehicles regarding a specified aspect of vehicle performance. An effectiveness of a software update targeted to the specified aspect of vehicle performance is determined based on the data, and a change in at least one of the plurality of vehicles is actuated when the determined effectiveness is below a specified threshold.

The instructions to determine the effectiveness of the software update can include instructions to apply a causal model to the received data.

The instructions to apply the causal model can include instructions to determine a conditional average treatment effect of the software update based on the data.

The instructions to determine a conditional average treatment effect of the software update based on the data can include instructions to use an S-learner, an X-learner, or a causal tree algorithm.

The instructions to apply the causal model can include instructions to determine an average treatment effect of a vehicle feature based on the determined conditional average treatment effect for the software update.

The instructions to apply the causal model can include instructions to sum the effectiveness of the software update and one or more subsequent software updates.

The instructions to apply the causal model can include instructions to group the plurality of vehicles by features.

The instructions to actuate a change in the at least one of the plurality of vehicles can include instructions to revert the software update to a previous version and/or disable a component of the at least one of the plurality of vehicles.

The received data can include warranty claim information and/or vehicle diagnostic trouble codes.

The instructions to actuate a change in the at least one of the plurality of vehicles can include instructions to revert the software update to a previous version and/or disable a component for a group of the plurality of vehicles having a specified feature.

Disclosed herein is a method for actuating a change in a vehicle including receiving data corresponding to a plurality of vehicles regarding a specified aspect of vehicle performance. The method can include determining an effectiveness of a software update targeted to the specified aspect of vehicle performance based on the data, and actuating a change in at least one of the plurality of vehicles when the determined effectiveness is below a specified threshold.

Determining the effectiveness of the software update can include applying a causal model to the received data.

Applying the causal model can include determining a conditional average treatment effect of the software update based on the data.

Determining a conditional average treatment effect of the software update based on the data can include using an S-learner, an X-learner, or a causal tree algorithm.

Applying the causal model can include determining an average treatment effect of a vehicle feature based on the determined conditional average treatment effect for the software update.

Applying the causal model can include summing the effectiveness of the software update and one or more subsequent software updates.

Applying the causal model can include grouping the plurality of vehicles by features.

Actuating a change in the at least one of the plurality of vehicles can include reverting the software update to a previous version and/or disabling a component of the at least one of the plurality of vehicles.

The received data can include warranty claim information and/or vehicle diagnostic trouble codes.

Actuating a change in the at least one of the plurality of vehicles can include reverting the software update to a previous version and/or disabling a component for a group of the plurality of vehicles having a specified feature.

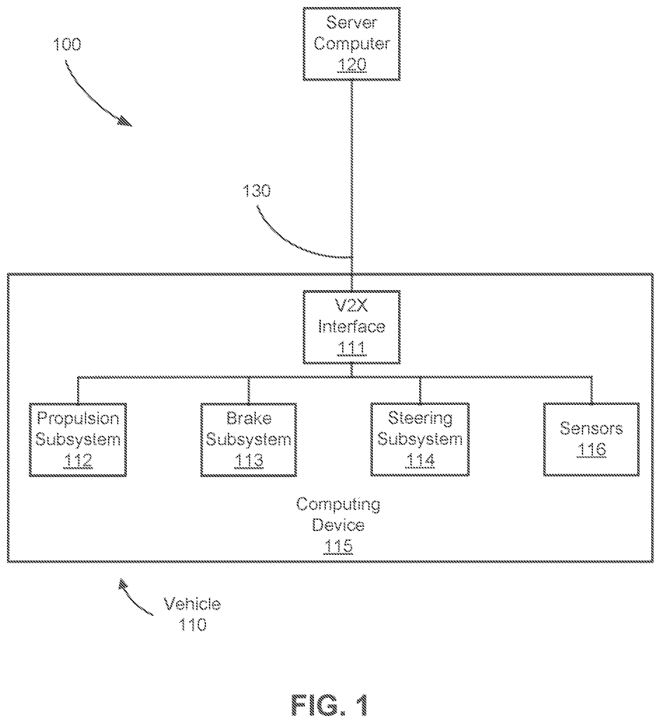

FIG. 1 is a diagram of an example system 100. The system 100 includes a vehicle 110, operable by a user and/or according to control by a computing device or devices 115 which can include one or more vehicle electronic control units (ECUs) or computers, such as are known, possibly including additional hardware, software, and/or programming as described herein. A computing device 115 can receive data regarding the operation of the vehicle 110 from sensors 116. A computing device 115 may operate the vehicle 110 or components thereof instead of or in conjunction with control by a human user. The system 100 can further include a remote (i.e., external to the vehicle) server computer 120 that can communicate with the vehicle 110 via a network 130.

The computing device 115 can include one or more processors and one or more memory devices such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc.

The computing device 115 may include or be communicatively coupled to, e.g., via a vehicle communications bus as described further below, more than one computing device, e.g., controllers, ECUs, or the like included in the vehicle 110 for monitoring and/or controlling various vehicle subsystems, e.g., a propulsion subsystem 112, a brake subsystem 113, a steering subsystem 114, etc. The computing device 115 is generally arranged for communications on a vehicle communication network, e.g., including a bus in the vehicle 110 such as a controller area network (CAN) or the like. The vehicle network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface with a remote server computer 120, e.g., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, e.g., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles through V2X (vehicle-to-everything) interface 111 using vehicle-to-vehicle (V-to-V) networks, e.g., according to including cellular communications (C-V2X) wireless communications cellular, Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to the server computer 120 or user mobile device.

As already mentioned, generally included in instructions stored in the memory and executable by the processor of the computing device 115 is programming for operating one or more vehicle components, e.g., braking, steering, propulsion, etc. Using data received in the computing device 115, e.g., the sensor data from the sensors 116, the server computer 120, etc., the computing device 115 may make various determinations and/or control various vehicle components and/or operations.

Each of the subsystems 112, 113, 114 may include respective processors and memories and/or one or more actuators. The subsystems 112, 113, 114 may be programmed and connected to a vehicle communications bus, such as a controller area network (CAN) bus or local interconnect network (LIN) bus, to receive instructions from the computing device 115 and control actuators based on the instructions.

The vehicle 110 is generally a land-based vehicle 110 having three or more wheels, e.g., a passenger car, light truck, etc. The vehicle 110 includes one or more sensors 116, the V2X interface 111, the computing device 115 and one or more subsystems 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles. The sensors 116 may further be used to collect data including dynamic vehicle data related to operations of the vehicle 110 such as velocity, yaw rate, steering angle, engine speed, brake pressure, oil pressure, the power level applied to subsystems 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2X interface 111 and computing device 115, and therefore these features will not be described further. A server computer 120 can be used to develop and train software that can be transmitted to a computing device 115 in a vehicle 110.

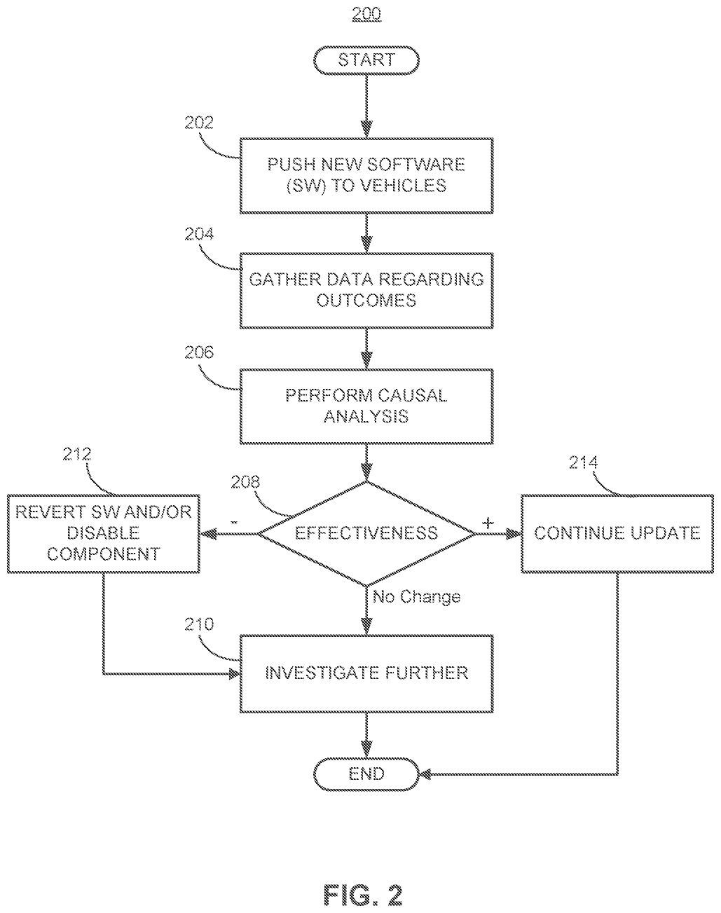

FIG. 2 is a flow diagram illustrating an example process 200 for software update based vehicle change actuation. Process 200 can be implemented in a computing device 115 included in a vehicle 110 and/or a server computer 120 in communication with the computing device 115 via a network 130. Process 200 includes multiple blocks that can be executed in the illustrated order. Process 200 could alternatively or additionally include more or fewer blocks and/or include the blocks executed in different orders.

Process 200 begins at block 202 when e.g., the server computer 120 pushes new software or a software update to a plurality or fleet of vehicles. In the context of this document, to “push” software or a software update means to provide the software via a network 130 to a computing device 115, typically at a scheduled time and/or a scheduled event, e.g., a vehicle 110 reaching a non-operational, e.g., parked, propulsion-off and/or key-off, state, at or after a specified time. In examples, a software update can be pushed via an over-the-air (OTA) update. Once the software update is created and before it is pushed to the fleet of vehicles, it can be tested using A/B testing on test vehicles (i.e., testing in which random variants are provided to different vehicles in a controlled manner to evaluate effects of the variants). Observational data from testing the test vehicles can be used to update the software as warranted prior to deploying on consumer vehicles. In some examples, the software update can be sent over-the-air (OTA) to update a designated target ECU module (target ECU T*).

As an example, a particular model of vehicle could be experiencing an unexpected or unusual battery drain (e.g., above a threshold of typically expected battery drain) after key-off when the vehicle is not in use, leading to depleted batteries and in some cases early battery replacement under warranty. The battery drain issue could also be correlated with a particular DTC. In this case, the software update could be provided to address the battery drain by changing the logic in the target ECU T* for battery usage.

At block 204 the server computer 120 gathers data regarding the outcomes of the software update. The server computer 120 can receive data corresponding to the plurality of vehicles regarding a specified aspect of vehicle performance, such as the particular DTC associated with an unusual or unexpected battery drain. The received data can include, e.g., warranty claim information, vehicle diagnostic trouble codes, and specific performance parameters, such as percent of vehicle key cycles having an abnormal battery drain or state-of-charge (SOC) decrease. In an example an abnormal battery drain is an amount of depletion after a key-off event of greater than a specified drain threshold e.g., eight percent, within a certain threshold amount of time, e.g., one hour. The drain threshold and time threshold can be based on empirical testing of a particular battery platform and/or design parameters.

In addition to the observational data regarding outcomes, vehicle characteristics including vehicle features are received by the server computer 120. Highly correlated vehicle features are grouped together to narrow the number of features to be analyzed, and a representative feature can be selected for each group. Feature grouping algorithms can identify those highly correlated features. The algorithm can be based on statistical metrics to determine the correlation/association of each pair of features, including correlation algorithms, mutual information, etc. The feature groups are matched to the treatment and control groups so that both the treatment and control groups have similar feature groups. Vehicle features are components, groups of components, and/or systems that are controlled or affected by software. In an example, these features can be grouped by functional packages, such as an entertainment package that provides playback of audio and/or video and that typically includes components such as screens, video players, speakers, etc. The control and treatment groups can have the same feature groups, although the distribution of a feature in treatment and control groups may be different. For example, one feature value can range from 0-10 in the control group, while in the treatment group, the value of this feature can range from 9-10 only. The matching steps help to make sure that the distribution for feature values in both control and treatment groups are similar.

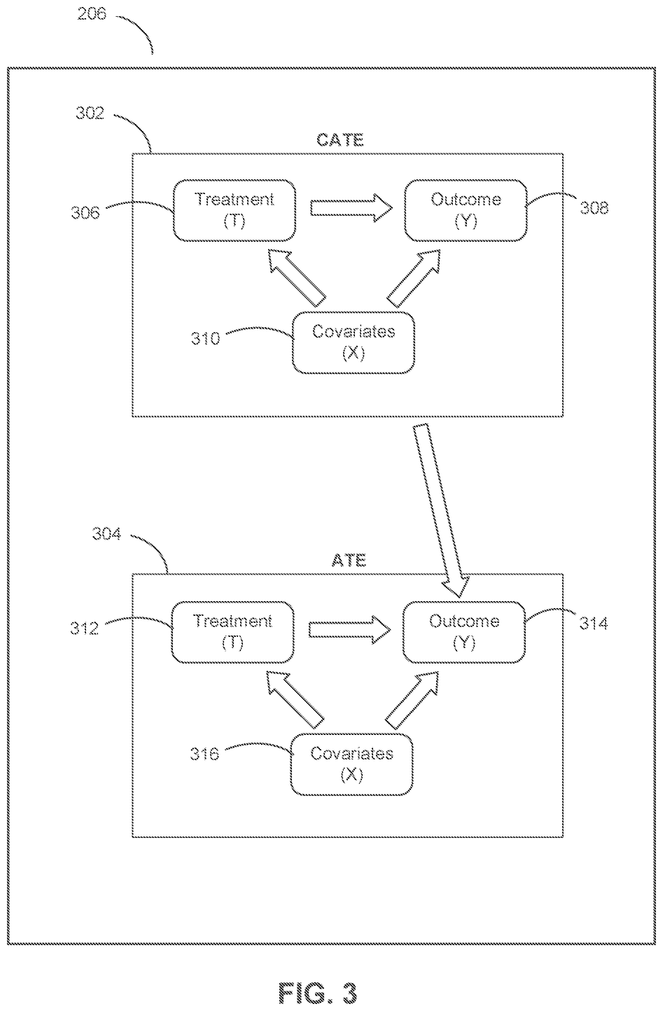

At block 206 server computer 120 performs a causal machine learning analysis to determine the effectiveness of the software update. Once the data is gathered in block 204, including vehicle features, warranty information, and vehicle telematics (e.g., diagnostic trouble codes) for vehicles with the software update (i.e., treatment group) and vehicles without the software update (i.e., control group), causal machine learning algorithms (e.g., x-learner, s-learner, causal tree, etc.) are applied to the gathered data to build a causal model for performing CATE calculations. As explained with respect to FIGS. 3-7, the causal model is then used to perform a two-level causal analysis. Causal machine learning is a branch of machine learning that focuses on understanding the cause-and-effect relationships in data. Causal machine learning can estimate the causal effect of treatment T on outcome Y for vehicles with observed covariate features X. Causal ML, for example, is a Python package that provides suitable examples of machine learning algorithms to estimate the CATE from experimental or observational data.

At decision block 208 the server computer 120 evaluates an effectiveness of the software update targeted to the specified aspect of vehicle performance based on the data. The effectiveness can be positive, negative, or no effect. For example, continuing the example of an abnormal (i.e., unexpected or unusual) battery drain, a positive effectiveness can be indicated by a decrease in the frequency of the particular DTC associated with the battery drain. A negative effectiveness can be indicated by an increase in the frequency of the particular DTC. No effect can be indicated by no change in the frequency of the particular DTC.

If the software update has no effect, the process 200 proceeds to block 210 for further investigation. If the software update has a negative effect, the process 200 proceeds to block 212 to actuate a change in the vehicle. If the software update has a positive effect, the update is continued for some or all of eligible vehicles. Typically, a software update is applied to vehicles for which it has been determined that the software update will have a positive effect. In some examples, there may be a group or subset of vehicles, typically a minority, that see no effect or a negative effect from the software update (e.g., vehicles with or without certain features). In these cases, the software update determined to have no and/or negative effect can be discontinued or not provided for the subset of vehicles.

At block 210 if the software update has no effect, the server computer 120 can send data about this result to a remote computer such as the server 120, e.g., to inform a software update team. The process 200 typically ends following the block 210.

At block 212 if the software update has a negative effect, the server computer 120 can actuate a change in the vehicles for which the update has a negative effect. The server computer 120 can actuate a change in the vehicles when the determined effectiveness is below a specified threshold, e.g., when the effectiveness is less than zero. In some examples, the effectiveness threshold does not have to be zero and can be a positive or negative value that is close to zero, e.g., 0.001, −0.001. Actuating a change in the respective vehicles can include reverting the software update to a previous version and/or disabling a component and/or feature of the vehicles. For example, in the battery drain example, zone lighting could be disabled. In this or other examples cameras, lights, etc., could be turned off and features can be disabled or restarted.

At block 214, if the software update has a positive effect, the server computer 120 can continue updating the vehicles. In some examples, there may be a small group or subset of vehicles that see no effect or a negative effect from the software update (e.g., vehicles with or without certain features). In these cases, the software update can be discontinued for the subset of vehicles.

With reference to FIG. 3, the causal analysis block 206 can include a first level 302 and a second level 304. The first level 302 calculates CATE for the designed software update on outcomes related to vehicle performance. The second level 304 calculates average treatment effect (ATE) for feature groups on CATE values calculated from the previous first level 302. CATE is a quantity representing an individualized causal effect, defined as a difference between the expected outcomes Y 308 of the treatment (T=1) 306 and control (T=0) groups conditioned on Covariates X 310: CATE(x)=E[Y(T=1)−Y(T=0)|X=x]. The ATE is defined as the average difference in outcomes Y 314 between the treatment (T=1) 312 and control (T=0) groups: ATE=E[Y(T=1)−Y(T=0)].

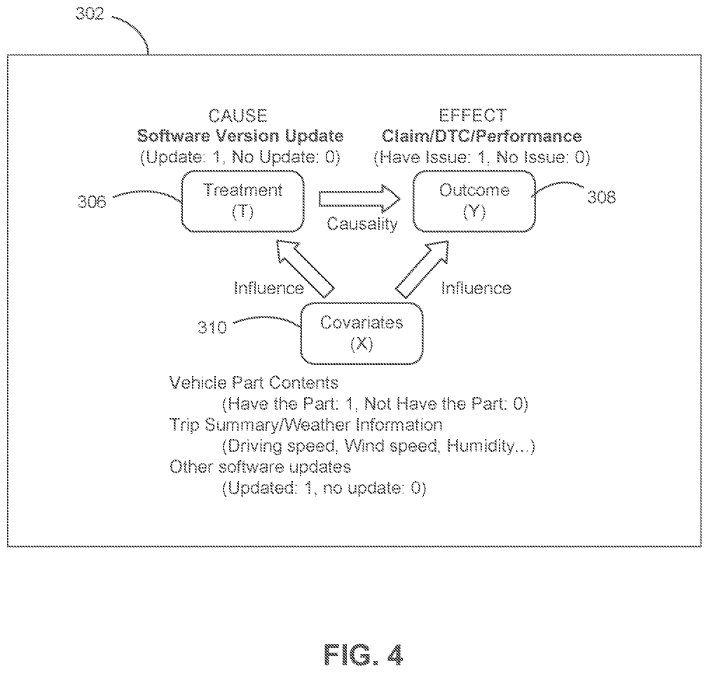

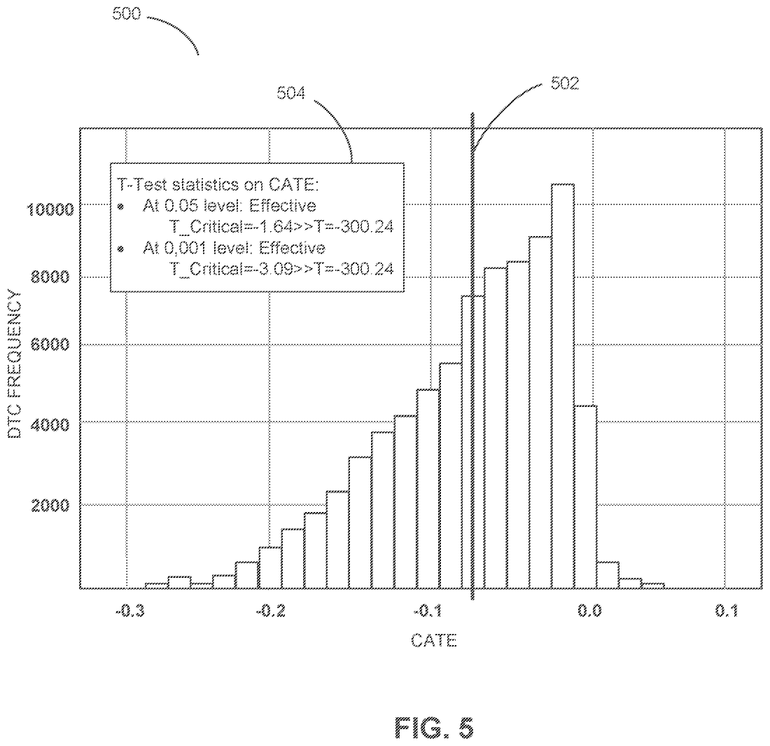

With reference to FIGS. 4 and 5, the first level 302 calculates CATE where the treatment T 306 (i.e., cause) is the software update and the outcome Y 308 (i.e., effect) is the specified aspect of vehicle performance (e.g., warranty claims, DTC, or performance). The first level calculates CATE for the designed software update on outcomes related to vehicle performance. In other words, the first level indicates how the containment action, i.e., software update, changes the vehicle performance aspect of interest. For example, the first level can determine if the software update increases or decreases the incidence of a particular diagnostic trouble code (DTC). In an example, the covariates X 310 can include vehicle part contents, trip summary/weather information, and or other software updates.

FIG. 5 is a histogram 500 of the distribution of CATE values in this fleet with respect to the frequency of the particular DTC (i.e., battery drain). The mean value 502 is negative, which indicates that the treatment (i.e., software update) causes the value of the outcome (i.e., DTC) to be reduced from 1 (Have issue) to 0 (No issue). In other words, the software update reduces the incidence of the DTC associated with the aspect of vehicle performance of interest (e.g., battery drain). The effectiveness, therefore, is positive when the mean of the CATE values is negative.

Based on the t-test result 504 shown in FIG. 5, it can be concluded that the treatment is effective for this fleet of vehicles. The t-test analysis can help prevent misunderstanding a reduction in the frequency of DTC caused by covariates as being caused by the treatment. A t-test is an inferential statistic that can be used to determine if there is a significant or meaningful difference between the means of two groups and how they are related.

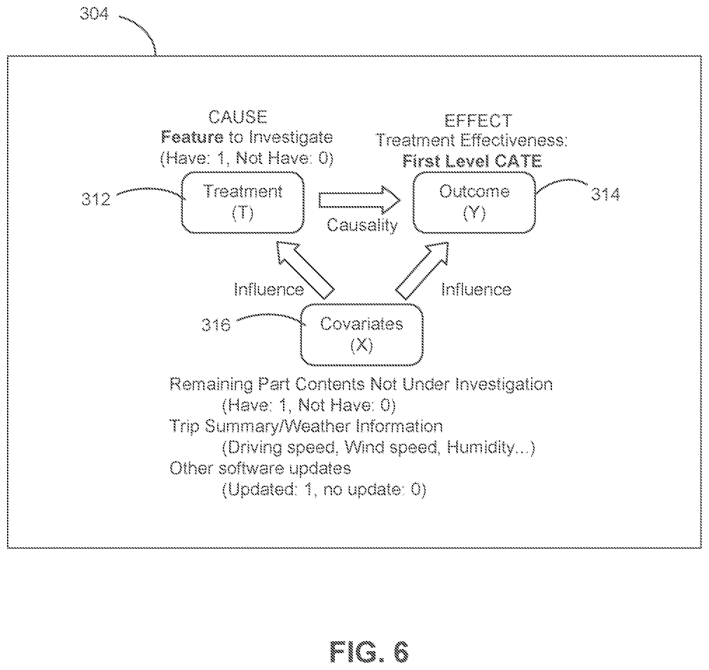

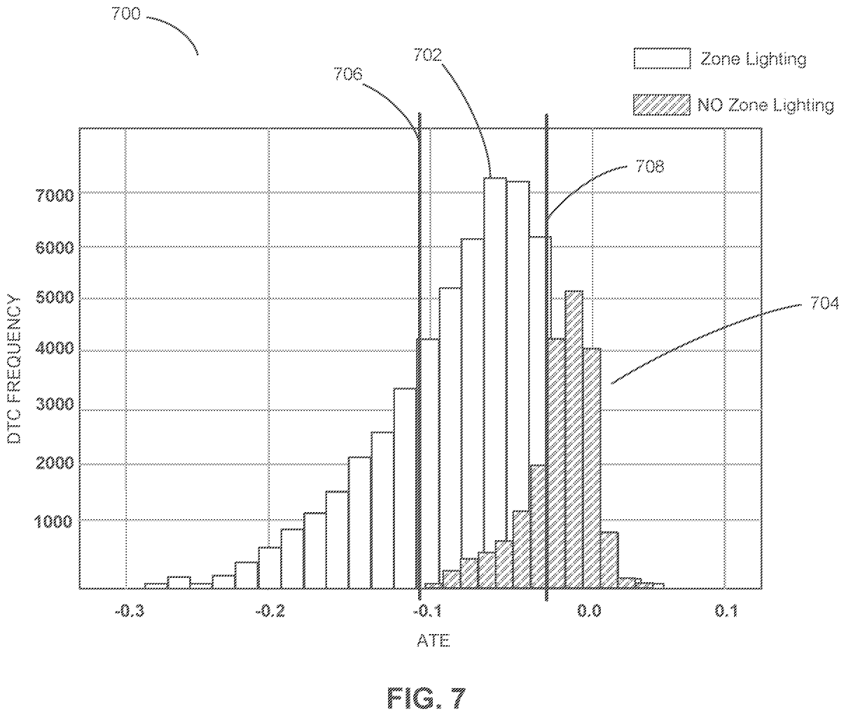

With reference to FIGS. 6 and 7, the second level 304 calculates ATE where the treatment T 312 (i.e., cause) is the feature to investigate and the outcome Y 314 (i.e., effect) is the CATE from the first level 302. The second level calculates average treatment effect (ATE) for feature groups on CATE calculated from the previous first level step. The second level 304 indicates how different groups of features affect the change in CATE. This can be used to indicate which vehicle features are associated with changes in the vehicle performance caused by the software update. The second level 304, therefore, calculates the causal effect for each feature on the outcome.

In this case, the treatment T 312 is the feature of interest (e.g., zone lighting), and the covariates X 316 are other features, while the outcome Y 314 now becomes the treatment effect (the CATE) that was calculated in the first level 302. The calculated causal effect for each feature on the outcome can be used to rank the feature groups to identify which features have the most effect on the outcome for further investigation.

In addition to understanding if the treatment is effective or not at a fleet level, the effect of different features on the treatment effect of the CATE values can also be investigated. In this example, the top representative feature group includes the zone lighting. The histograms 702 and 704 in FIG. 7 show the effect that the lighting zone feature has on the treatment effect. Histogram 702 represents the distribution of ATE values in vehicles having the zone lighting feature with respect to the frequency of the particular DTC (i.e., battery drain). Histogram 704 represents the distribution of ATE values in vehicles that do not have the zone lighting feature with respect to the frequency of the particular DTC (i.e., battery drain). Comparing the means 706 and 708 for the with and without zone lighting histograms 702 and 704, respectively, it can be seen that the zone lighting feature drives the mean ATE negative (i.e., drives the incidence of DTC lower), while vehicles without the zone lighting feature are less affected by the software update.

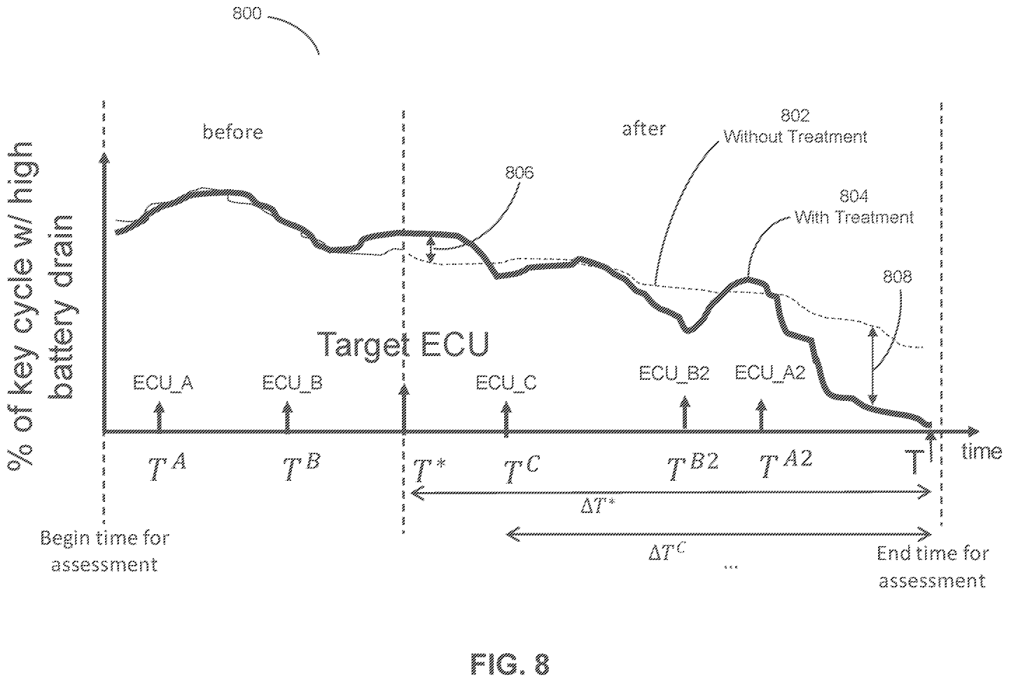

As shown in FIG. 8, the causal effect of multiple software updates over time is evaluated by summing the effectiveness of the target software update and one or more subsequent software updates. In this example graph 800, the aspect of performance is the percent of key cycles that experienced high battery drain (e.g., SOC drop >8%). Battery drain issues in these vehicles can be addressed by e.g., a software update to change the logic for battery usage. For example, the software update can be an OTA update designed to update a designated target ECU module (target ECU T*). During the time period of treatment effectiveness assessment, other ECU modules can also be updated, and those updates might also affect the battery drain issue. Individual vehicles will update the software over different time frames (the time can be weeks or months, or more), which naturally forms the data with vehicles that have different versions of software at a given period of time. At a given time T, the treatment effect can be expressed as Equation 1.

$${E}_{1}^{*} = {E}_{0}^{*} + {δ}_{*} \frac{\partial {E}_{1}^{*}}{\partial {T}^{*}} Δ {T}^{*} + {δ}_{C} \frac{\partial {E}_{1}^{*}}{\partial {T}^{C}} Δ {T}^{C} + {δ}_{B 2} \frac{\partial {E}_{1}^{*}}{\partial {T}^{B 2}} Δ {T}^{B 2} + {δ}_{A 2} \frac{\partial {E}_{1}^{*}}{\partial {T}^{A 2}} Δ {T}^{A 2} + \qquad ( 1 )$$

Where N is the number of vehicles [1,2,3 . . . n, . . . . N]; M is the number of software updates [A,B,C . . . ,m, . . . M]; E₁^{m} indicates treatment applied and E₀^{m} indicates treatment was not applied; E* is the expected outcome under the software update (applied on a target ECU T*); and δₘ indicates if a vehicle has had the m^{th} software update or not (1 or 0).

The treatment effect is the difference between an expected value with treatment applied (solid line 804) versus expected value without treatment applied (dashed line 802) and is expressed as a causal difference in Equation 2.

$$Casual Difference = {E}_{1}^{*} ( T ) - {E}_{0}^{*} ( T ) \qquad ( 2 )$$

If the causal difference is less than zero, the update drives a percentage of battery drain lower indicating that the treatment is effective; a causal difference greater than zero, indicates an adverse effect; if the causal difference equals zero, there is no effect. For example, the causal difference 806 between the expected value with treatment applied (solid line 804) versus the expected value without treatment applied (dashed line 802) at time T* is positive indicating that the effectiveness is negative, having an adverse effect. However, after time T^{A2} the causal difference 808 between the expected value with treatment applied (solid line 804) versus the expected value without treatment applied (dashed line 802) is negative indicating that the effectiveness is positive.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random-access memory, etc.

A computer-readable medium (also referred to as a processor-readable medium) includes any non-transitory (i.e., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention. Any use of “based on” and “in response to” herein, including with reference to media, processes, systems, methods, etc. described herein, indicates a causal relationship, not merely a temporal relationship.

What is claimed is:

1. A system, comprising:
a computer that includes a processor and a memory, the memory including instructions executable by the processor to:
receive data corresponding to a plurality of vehicles regarding a specified aspect of vehicle performance;
determine an effectiveness of a software update targeted to the specified aspect of vehicle performance based on the data; and
actuate a change in at least one of the plurality of vehicles when the determined effectiveness is below a specified threshold.

2. The system of claim 1, wherein the instructions to determine the effectiveness of the software update include instructions to apply a causal model to the received data.

3. The system of claim 2, wherein the instructions to apply the causal model include instructions to determine a conditional average treatment effect of the software update based on the data.

4. The system of claim 3, wherein the instructions to determine a conditional average treatment effect of the software update based on the data include instructions to use an S-learner, an X-learner, or a causal tree algorithm.

5. The system of claim 3, wherein the instructions to apply the causal model include instructions to determine an average treatment effect of a vehicle feature based on the determined conditional average treatment effect for the software update.

6. The system of claim 2, wherein the instructions to apply the causal model include instructions to sum the effectiveness of the software update and one or more subsequent software updates.

7. The system of claim 2, wherein the instructions to apply the causal model include instructions to group the plurality of vehicles by features.

8. The system of claim 1, wherein the instructions to actuate a change in the at least one of the plurality of vehicles include instructions to revert the software update to a previous version and/or disable a component of the at least one of the plurality of vehicles.

9. The system of claim 1, wherein the received data includes warranty claim information and/or vehicle diagnostic trouble codes.

10. The system of claim 1, wherein the instructions to actuate a change in the at least one of the plurality of vehicles include instructions to revert the software update to a previous version and/or disable a component for a group of the plurality of vehicles having a specified feature.

11. A method for actuating a change in a vehicle, comprising:
receiving data corresponding to a plurality of vehicles regarding a specified aspect of vehicle performance;
determining an effectiveness of a software update targeted to the specified aspect of vehicle performance based on the data; and
actuating a change in at least one of the plurality of vehicles when the determined effectiveness is below a specified threshold.

12. The method of claim 11, wherein determining the effectiveness of the software update includes applying a causal model to the received data.

13. The method of claim 12, wherein applying the causal model includes determining a conditional average treatment effect of the software update based on the data.

14. The method of claim 13, wherein determining a conditional average treatment effect of the software update based on the data includes using an S-learner, an X-learner, or a causal tree algorithm.

15. The method of claim 13, wherein applying the causal model includes determining an average treatment effect of a vehicle feature based on the determined conditional average treatment effect for the software update.

16. The method of claim 12, wherein applying the causal model includes summing the effectiveness of the software update and one or more subsequent software updates.

17. The method of claim 12, wherein applying the causal model includes grouping the plurality of vehicles by features.

18. The method of claim 11, wherein actuating a change in the at least one of the plurality of vehicles includes reverting the software update to a previous version and/or disabling a component of the at least one of the plurality of vehicles.

19. The method of claim 11, wherein the received data includes warranty claim information and/or vehicle diagnostic trouble codes.

20. The method of claim 11, wherein actuating a change in the at least one of the plurality of vehicles includes reverting the software update to a previous version and/or disabling a component for a group of the plurality of vehicles having a specified feature.
